(19) United States
(12) Patent Application Publication
(10) Pub. No.: US 2007/0091660 A1
(43) Pub. Date: Apr. 26, 2007

(54) MONITOR AND DC/AC CONVERTER

(75) Inventors: Po-Wen Wang, Taipei County (TW); Chia-Tse Yeh, Taoyuan County (TW); Chien-Kun Huang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/538,450

(22) Filed: Oct. 4, 2006

(30) Foreign Application Priority Data
Oct. 21, 2005 (TW) 94136945

(51) Int. Cl. H02M 7/537

(52) U.S. Cl. 363/131

(57) ABSTRACT

A monitor and a DC/AC converter thereof are provided. The monitor includes a lamp and a DC/AC converter. The DC/AC converter includes a pulse width modulation (PWM) unit, a DC/DC converting unit and a Royer circuit. The PWM unit is used for outputting a PWM signal whose pulse width is determined by a potential signal. The DC/DC converting unit receives and converts the first DC voltage to a second DC voltage whose potential is determined by the PWM signal. The Royer circuit generates an AC voltage to the lamp according to the second DC voltage. The DC/AC converter determines the potential of the AC voltage according to the potential signal. When the DC/AC converter operates in burst mode, the potential signal is alternated between a high potential and a low potential, such that the AC voltage outputted is in burst mode.

The application claims the benefit of Taiwan application Serial No. 94136945, filed Oct. 21, 2005, the subject matter of which is incorporated herein by reference.

### BACKGROUND OF THE INVENTION

1. Field of the Invention

The invention relates in general to a monitor and a DC/AC converter thereof, and more particularly to a monitor and a DC/AC converter thereof operating in bust mode.

2. Description of the Related Art

Referring to FIG. 1, a block diagram of a conventional DC/AC converter is shown. The DC/AC converter 100 includes a DC/DC converting unit 110, a Royer circuit 120, a pulse width modulation (PWM) unit 130, and a feedback circuit 150. The DC/AC converter 100 is used for providing the lamp 140 with an AC voltage Va1 to emit a light.

The DC/DC converting unit 110 receives a voltage Vd1 for generating a voltage Vd2. The Royer circuit 120 provides the lamp 140 with the AC voltage Va1 according to the voltage Vd2. The lamp 140 generates a feedback signal Fb1 to the feedback circuit 150. The feedback circuit 150 outputs a feedback signal Fb2 to the PWM unit 130. The PWM unit 130 controls the voltage Vd2 provided by the DC/DC converting unit 110 according to the feedback signal Fb1 and the brightness adjusting signal Ba to stabilize the AC voltage Va1 of the Royer circuit 120.

The brightness adjusting signal Ba enables the DC/AC converter 100 to operate in continue mode. Referring to FIG. 2, a wave-pattern of the brightness adjusting signal Ba and the current I1 is shown. It is depicted from FIG. 2 that the current I1 is in continuous mode.

The accreditation by the Swedish Confederation of Professional Employees (TCO) requires the product to comply with the international standards in the aspects of ecology, energy radiation and ergonomics such that both the quality of office facilities and environmental sign system can be improved. However, the standards of monitor requested by the TCO are getting tougher and tougher, and some of the lamps request the current provided to the lamp to be constant. The above DC/AC converter operating in continuous mode fails to meet the TOO requirement of brightness change.

### SUMMARY OF THE INVENTION

It is therefore an object of the invention to provide a monitor and a DC/AC converter thereof whose Royer circuit operates in bust mode to comply with the TCO standard of monitor brightness.

The invention achieves the above-identified object by providing a monitor. The monitor includes a lamp and a DC/AC converter. The DC/AC converter includes a pulse width modulation (PWM) unit, a DC/DC converting unit and a Royer circuit. The PWM unit is used for outputting a PWM signal The DC/DC converting unit receives and converts a first DC voltage to a second DC voltage whose potential is determined by the PWM signal. The Royer circuit generates an AC voltage to the lamp according to the second DC voltage. The DC/AC converter determines the potential of the AC voltage according to the potential signal. When the DC/AC converter operates in burst mode, the potential signal is alternated between a high potential and a low potential, such that the AC voltage outputted is in burst mode.

The invention further achieves the above-identified object by providing a DC/AC converter. The DC/AC converter includes a PWM unit, a DC/DC converting unit and a Royer circuit. The PWM unit is used for outputting a PWM signal whose pulse width is determined by a potential signal. The DC/DC converting unit receives and converts a first DC voltage to a second DC voltage whose potential is determined by the PWM signal. The Royer circuit generates an AC voltage according to the second DC voltage. The DC/AC converter determines the potential of the AC voltage according to the potential signal. When the DC/AC converter operates in burst mode, the potential signal is alternated between a high potential and a low potential, such that the AC voltage outputted is in burst mode.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional DC/AC converter (Prior Art);

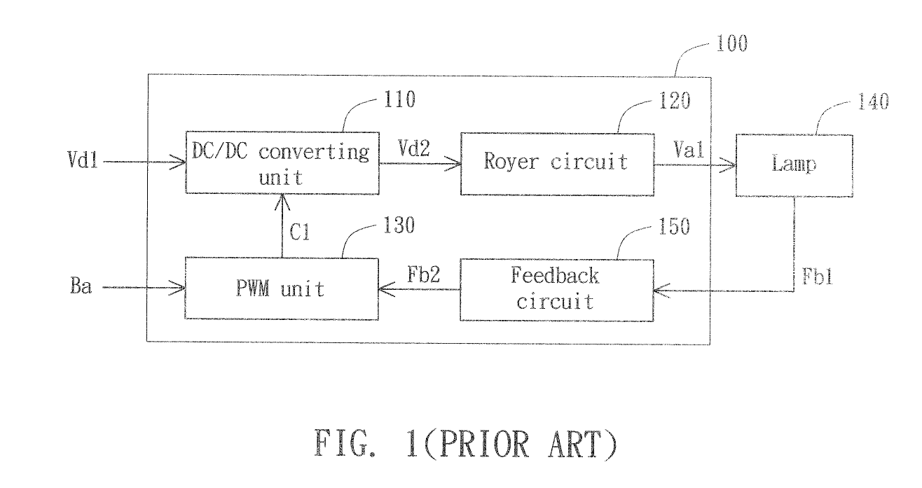

FIG. 2 is a wave-pattern of the brightness adjusting signal Ba and the current I1;

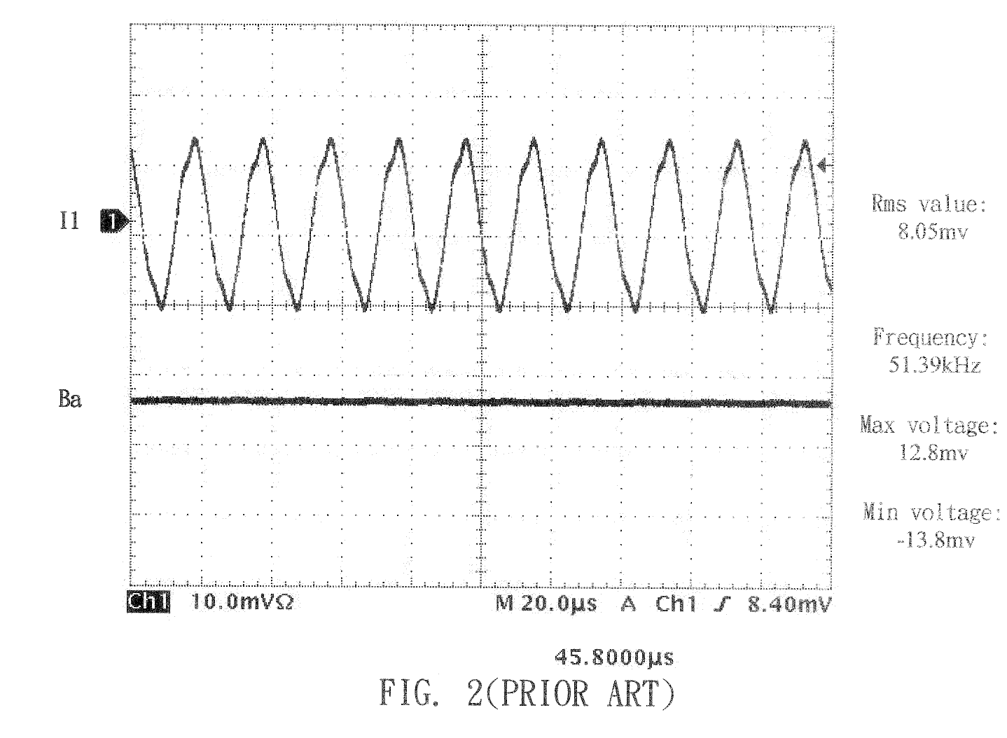

FIG. 3 is a block diagram of a display module according to a preferred embodiment of the invention;

FIG. 4 is a detailed circuit diagram of a PWM unit according to a first embodiment of the invention

FIG. 5 is a wave-pattern of the potential signal Bi and the AC current I2;

FIG. 6 is a detailed circuit diagram of a PWM unit according to a second embodiment of the invention.

### DETAILED DESCRIPTION OF THE INVENTION

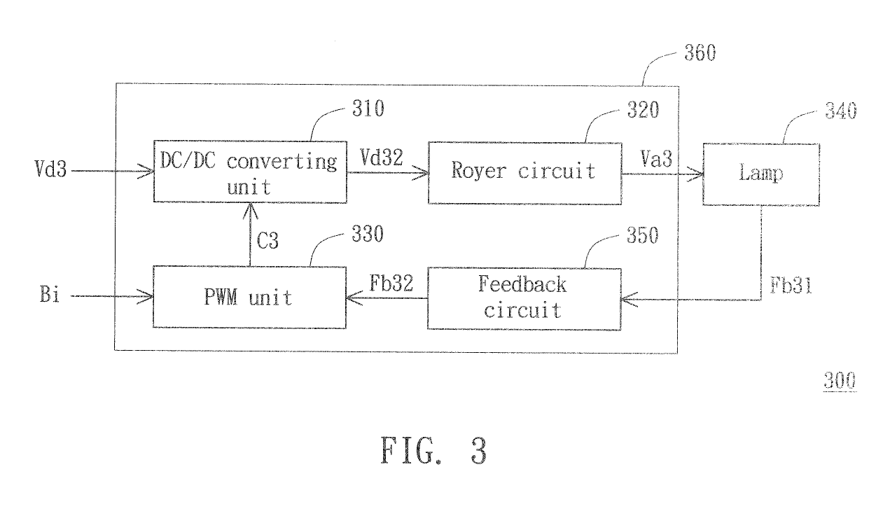

Referring to FIG. 3, a block diagram of a display module according to a preferred embodiment of the invention is shown. The monitor 300 includes a lamp 340 and a DC/AC converter 360. The DC/AC converter 360 includes a DC/DC converting unit 310, a Royer circuit 320; a pulse width modulation (PWM) unit 330 and a feedback circuit 350.

The PWM unit 330 receives a potential signal Bi to output a PWM signal C3 whose pulse width is determined by the potential signal Bi. The DC/DC converting unit 310 receives and converts a DC voltage Vd3 to a DC voltage Vd32 whose potential is determined by the PWM signal C3. The Royer circuit 320 outputs an AC voltage Va3 according to the DC voltage Vd32. Examples of the DC/DC converting unit 310 include a buck converter.

The DC/AC converter 360 operates in bust mode and determines the potential of the AC voltage Va3 according to the potential signal Bi. The potential signal Bi is alternated between a high potential and a low potential, such that the AC voltage Va3 outputted is in burst mode for enabling the Royer circuit 320 to operate in bust mode and adjust the AC voltage Va3 according to the second DC voltage Vd32.

The lamp 340 emits a light according to the AC voltage Va3 and generates a feedback signal Fb31. The feedback circuit 350 outputs a feedback signal Fb32 to the PWM unit 330 according to the feedback signal Fb31. The PWM unit 330 compares the potential signal Bi with the feedback signal Fb32 and then controls the DC/DC converting unit 310.

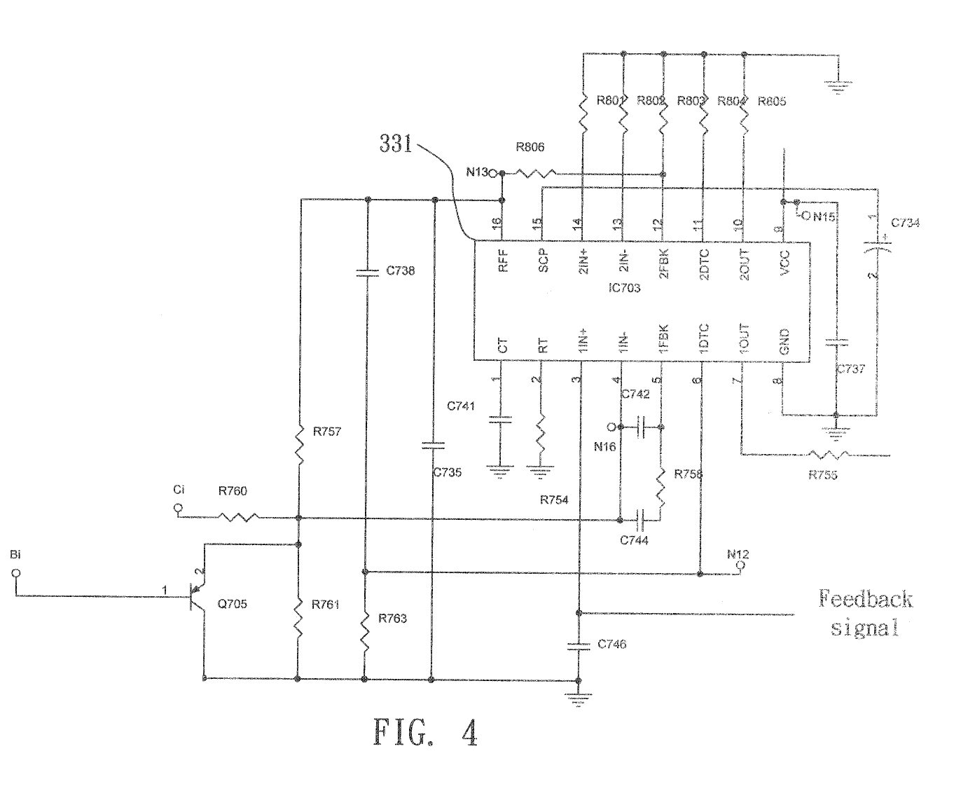

Referring to FIG. 4, a detailed circuit diagram of a PWM unit according to a first embodiment of the invention is shown. The PWM unit 330 includes a pulse width modulation controller 331 and a burst switch Q705. The pulse width modulation controller 331 controls the operation of the PWM unit 330 in the present embodiment of the invention, the burst switch Q705 is exemplified by a pnp bipolar junction transistor (BJT) whose emitter (E) is electrically connected to the negative input end of the comparer of the pulse width modulation controller 331, the collector (C) is coupled to the grounding end, and the base (B) receives the potential signal Bi. The PWM signal C3 is outputted via the resistor R755. The Royer circuit 320 operates in bust mode and generates an AC voltage Va3. The lamp 340 receives an AC current I2 generated by the AC voltage Va3 to generate brightness.

In FIG. 4, if the DC/AC converter 360 has to operate in continuous mode, then one end of the resistor R760 receives a potential signal Ci, which is a DC value. If the DC/AC converter 360 does not need to operate in continuous mode, then the resistor R760 is disconnected from the potential signal Ci, such that the DC/AC converter 360 only operates in bust mode.

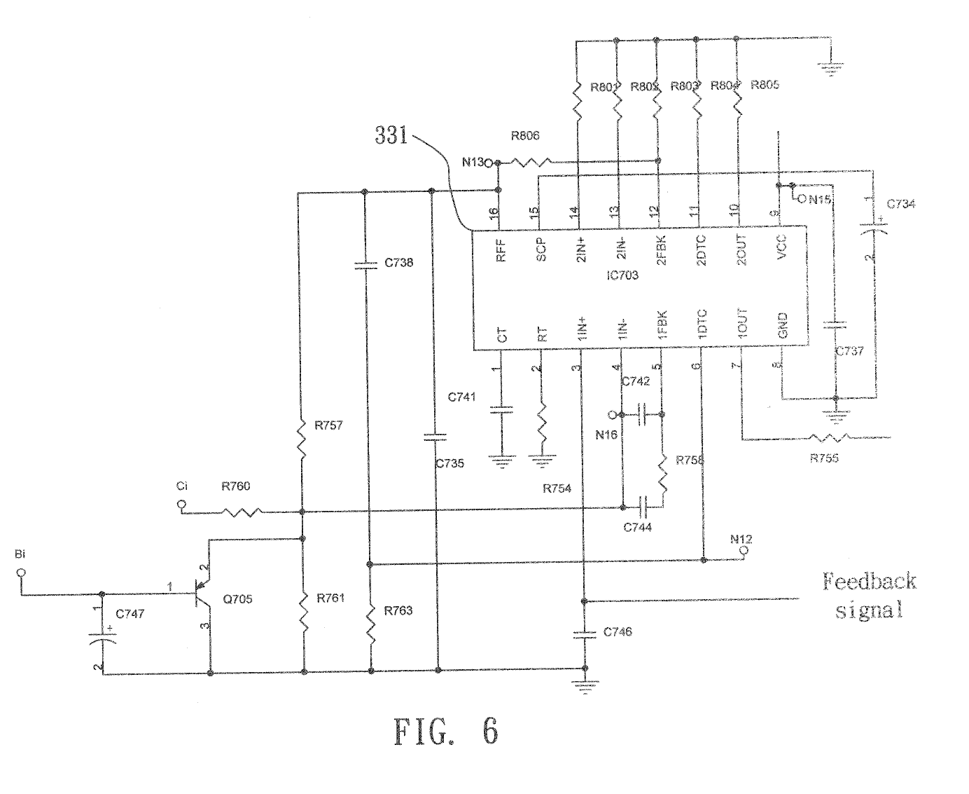

Referring to FIG. 6, a detailed circuit diagram of a PWM unit according to a second embodiment of the invention is shown. The PWM unit of the present embodiment of the invention differs with the PWM unit 330 of the first embodiment in further including a capacitor C747 coupled to the potential signal Bi, that is, between the base of the burst switch Q705 and the grounding end. The resistor R760 and the potential signal Ci, as disclosed in FIG. 4, are selectively added. The PWM unit of the present embodiment of the invention can replace the PWM unit 330 in the monitor 300.

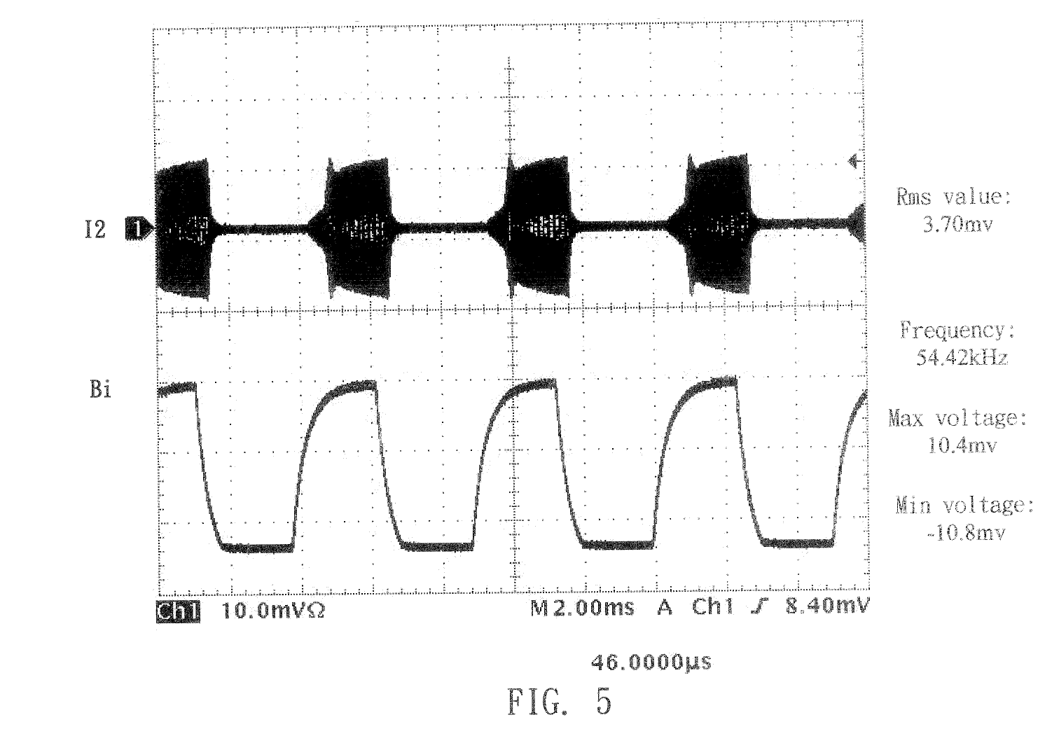

Referring to FIG. 5, a wave-pattern of the potential signal Bi and the AC current I2 is shown. It can be seen from FIG. 5 that the rms value of the AC current I2 varies with the duty ratio of the potential signal Bi. In terms of each period, when the potential signal Bi is at low level, the system is off and does not consume any power. Therefore, the power loss is lower than the conventional continuous mode when measured in a long term average basis.

The potential signal Bi enables the AC current I2 in bust mode to be enabled during a fixed ratio of a period. The brightness provided by the lamp 340 can be adjusted by adjusting the ratio of the AC current I2 being enabled during a period. The duration of the above period is short that the viewer will perceive the difference of brightness and darkness and will not perceive the flickering of the light.

The monitor and the DC/AC converter thereof disclosed in the above embodiments of the invention changes the mode of the Royer circuit from a conventional continue mode to a burst mode, not only complying with the TCO standard of monitor brightness but also having at least the following advantages of:

1. enhancing the differentiation in brightness changes;

2. increasing system efficiency; and

3. reducing system temperature.

While the invention has been described by way of example and in terms of a preferred embodiment, it is to be understood that the invention is not limited thereto. On the contrary, it is intended to cover various modifications and similar arrangements and procedures, and a scope of the appended claims therefore should be accorded the broadest interpretation so as to encompass all such modifications and similar arrangements and procedures.

What is claimed is:

1. A DC/AC converter, comprising:
a pulse width modulation (PWM) unit used for receiving a potential signal and outputting a PWM signal, wherein the pulse width of the PWM signal is determined by the potential signal;
a DC/DC converting unit used for receiving and converting a first DC voltage to a second DC voltage, wherein the potential of the second DC voltage is determined by the PWM signal; and
a Royer circuit used for generating an AC voltage according to the second DC voltage;
wherein, the DC/AC converter determines the potential of the AC voltage according to the potential signal, and the potential signal is alternated between a high potential and a low potential, such that the AC voltage outputted is in burst mode.

2. The DC/AC converter according to claim 1, wherein the PWM unit further comprises
a pulse width modulation controller; and
a burst switch whose one end is electrically connected to the pulse width modulation controller and the other end is coupled with a grounding end, wherein the potential signal controls whether the burst switch is turned on or not.

3. The DC/AC converter according to claim 2, wherein the PWM unit further comprises:
a capacitor coupled between the potential signal and the grounding end.

4. The DC/AC converter according to claim 1, wherein the DC/DC converting unit is a buck converter.

5. The DC/AC converter according to claim 1, wherein the AC voltage is used for driving a lamp.

6. The DC/AC converter according to claim 5, further comprising a feedback circuit, wherein the lamp outputs a first feedback signal to the feedback circuit according to the AC voltage, the feedback circuit outputs a second feedback signal to the PWM unit according to the first feedback signal, and the PWM unit adjusts the PWM signal according to the second feedback signal and the potential signal.

7. A monitor, comprising:
a lamp; and
a DC/AC converter, comprising:
a PWM unit used for receiving a potential signal and outputting a PWM signal;
a DC/DC converting unit used for receiving and converting a first DC voltage to a second DC voltage, wherein the potential of the second DC voltage is determined by the PWM signal; and
a Royer circuit used for generating an AC voltage to the lamp according to the second DC voltage;
wherein, the DC/AC converter determines the potential of the AC voltage according to the potential signal, and the potential signal is alternated between a high potential and a low potential, such that the AC voltage outputted is in burst mode.

8. The monitor according to claim 7, wherein the PWM unit further comprising:
a pulse width modulation controller; and
a burst switch whose one end is electrically connected to the pulse width modulation controller and the other end is coupled with a grounding end, wherein the potential signal controls whether the burst switch is turned on or not.

9. The monitor according to claim 8, wherein the PWM unit further comprising:
a capacitor coupled between the potential signal and the grounding end.

10. The monitor according to claim 7, wherein the DC/DC converting unit is a buck converter.

11. The monitor according to claim 7, wherein the DC/AC converter further comprising:
a feedback circuit, wherein the lamp outputs a first feedback signal to the feedback circuit according to the AC voltage, the feedback circuit outputs a second feedback signal to the PWM unit according to the first feedback signal, and the PWM unit adjusts the PWM signal according to the second feedback signal and the potential signal.
